(19) United States
(12) Patent Application Publication
(10) Pub. No.: US 2019/0011608 A1
(43) Pub. Date: Jan. 10, 2019

(54) METHOD FOR FABRICATING HIGH SAG LENS ARRAY AND HIGH SAG LENS ARRAY

(71) Applicant: HIMAX TECHNOLOGIES LIMITED, Tainan City (TW)

(72) Inventors: Teng-Te Huang, Tainan City (TW); Jen-Hui Lai, Tainan City (TW); Shu-Hao Hsu, Tainan City (TW)

(21) Appl. No.: 15/642,340

(22) Filed: Jul. 6, 2017

(51) Int. Cl. G02B 3/00; B29C 39/12; B29D 11/00

(52) U.S. Cl. CPC G02B 3/0031; B29L 2011/0016; B29D 11/00538; B29C 39/123

(57) ABSTRACT

The present invention provides a method for fabricating a high sag lens array a high sag lens array fabricated by a semiconductor process. The method comprises: individually jetting an optical glue material into a plurality of lens mold cavities of a mold to form a plurality of lens parts independently; exposing the lens parts to harden the optical glue material in the lens mold cavities; jetting an optical glue layer on the lens parts; forming a transparent substrate on the optical glue layer; exposing the optical glue layer to harden the optical glue layer and combine the transparent substrate, the optical glue layer, and the lens parts; and removing the mold to form the high sag lens array.

### BACKGROUND OF THE INVENTION

### 1. Field of the Invention

The present invention relates to a method of fabricating a lens array, and more particularly, to a method for fabricating a high sag lens array and a high sag lens array fabricated by a semiconductor process.

### 2. Description of the Prior Art

In general, a conventional method of fabricating a micro-lens array firstly injects an ultraviolet (UV) glue layer on a mold with a plurality of cavities, and then positions a glass substrate on the UV glue layer, and irradiates an UV ray while the glass substrate presses the UV glue layer to harden the UV glue layer and combine the glass substrate and the UV glue layer to fabricate the micro-lens array. However, when the cavities have a depth of over 300 micrometers, this method will cause unfilled forming or bubble in the UV glue layer in the cavities, and the incompletely forming process and the bubble issue would cause poor optical characteristics. In other words, when using the conventional method to fabricate a micro-lens array with a height of over 300 micrometers, there will be a deformation or a bubble issue on the top area of each micro-lens of the micro-lens array. Please refer to FIG. 1. FIG. 1 is a diagram showing a micro-lens 10 on a glass substrate 12 and a top view of the micro-lens 10 in the micro-lens array fabricated by the conventional method. As shown in FIG. 1, the micro-lens 10 has a serious bubble issue on the top area of the micro-lens 10.

### SUMMARY OF THE INVENTION

It is therefore one of the objectives of the present invention to provide a method for fabricating a high sag lens array and a high sag lens array fabricated by a semiconductor process, so as to solve the above problem.

In accordance with an embodiment of the present invention, a method for fabricating a high sag lens array is disclosed. The method comprises: individually jetting an optical glue material into a plurality of lens mold cavities of a mold to forma plurality of lens parts independently; exposing the lens parts to harden the optical glue material in the lens mold cavities; jetting an optical glue layer on the lens parts; forming a transparent substrate on the optical glue layer; exposing the optical glue layer to harden the optical glue layer and combine the transparent substrate, the optical glue layer, and the lens parts; and removing the mold to form the high sag lens array.

In accordance with an embodiment of the present invention, a high sag lens array is disclosed. The high sag lens array comprises: a glass substrate, an optical glue layer, and a plurality of lenses. The optical glue layer is formed on the glass substrate. The lenses are formed on the optical glue layer and have a height of over 300 micrometers.

Briefly summarized, the present invention can use a semiconductor process to fabricate a high sag lens array with a height of over 300 micrometers, each lens in the high sag lens array has a good formation without the bubble issue.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a micro-lens on a glass substrate and a top view of the micro-lens in the micro-lens array fabricated by the conventional method.

FIGS. 2-6 are sectional diagrams illustrating sequential procedures of fabricating a high sag lens array according to an embodiment of the present invention.

FIG. 7 is a diagram showing a top view of one lens part in the high sag lens array according to an embodiment of the present invention.

FIG. 8 is a flowchart of a method for fabricating a high sag lens array according to an embodiment of the present invention.

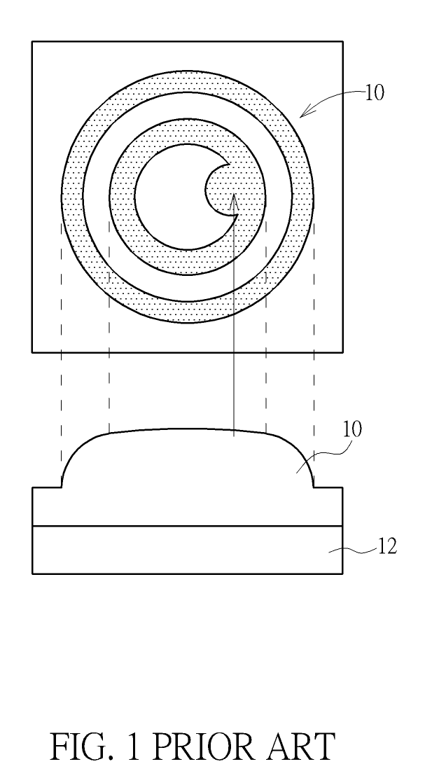

### DETAILED DESCRIPTION

Certain terms are used throughout the following description and the claims to refer to particular system components . As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to...”. The terms “couple” and “coupled” are intended to mean either an indirect or a direct electrical connection. Thus, if a first device couples to a second device, that connection may be through a direct electrical connection, or through an indirect electrical connection via other devices and connections.

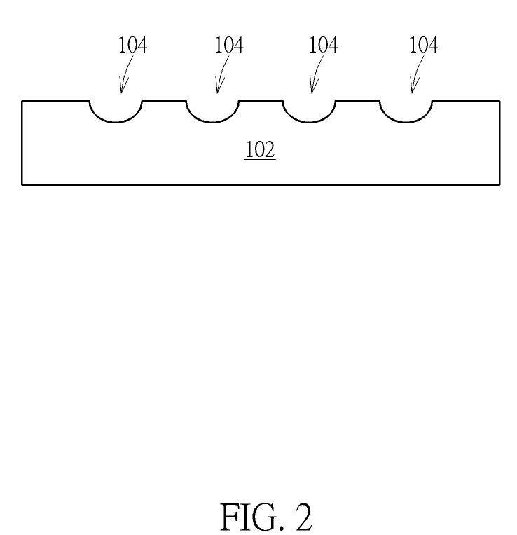

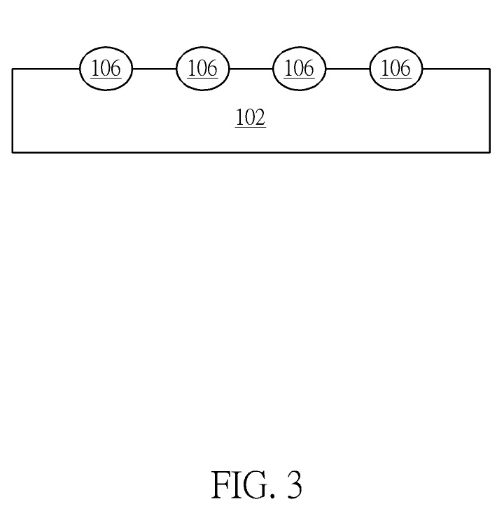

Please refer to FIGS. 2-6. FIGS. 2-6 are sectional diagrams illustrating sequential procedures of fabricating a high sag lens array 100 according to an embodiment of the present invention, wherein the high sag lens array 100 can be a micro-lens array utilized in a semiconductor chip. As shown in FIG. 2, a mold 102 having a plurality of lens mold cavities 104 is formed, wherein the lens mold cavities can have a depth of over 300 micrometers. As shown in FIG. 3, an optical glue material is individually jetted into the lens mold cavities 104 of the mold 102 to form a plurality of lens parts 106 independently, wherein the optical glue material can be an ultraviolet (UV) glue material. For example, the present invention can jet the optical glue material one by one into the lens mold cavities 104, or two by two into the lens mold cavities 104, or a batch by a batch into the lens mold cavities 104. Next, the lens parts 106 are exposed to harden the optical glue material in the lens mold cavities 104. For example, the present invention can irradiate an UV ray to the lens parts 106 to harden the optical glue material in the lens mold cavities 104.

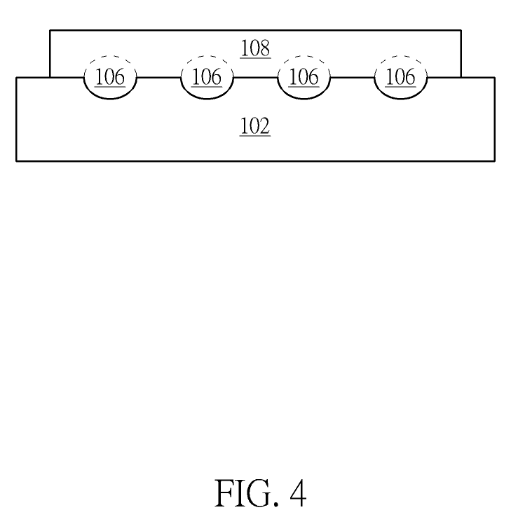

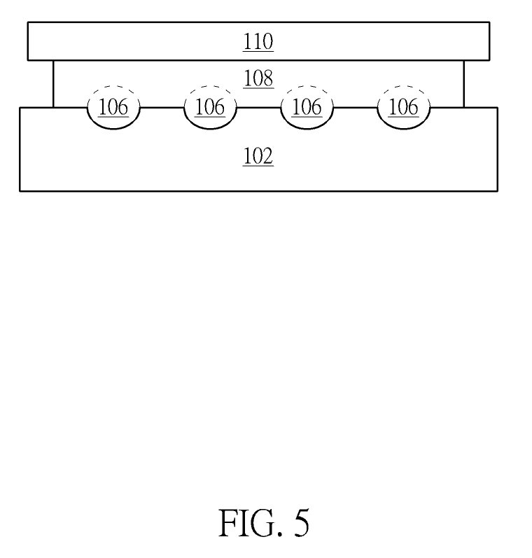

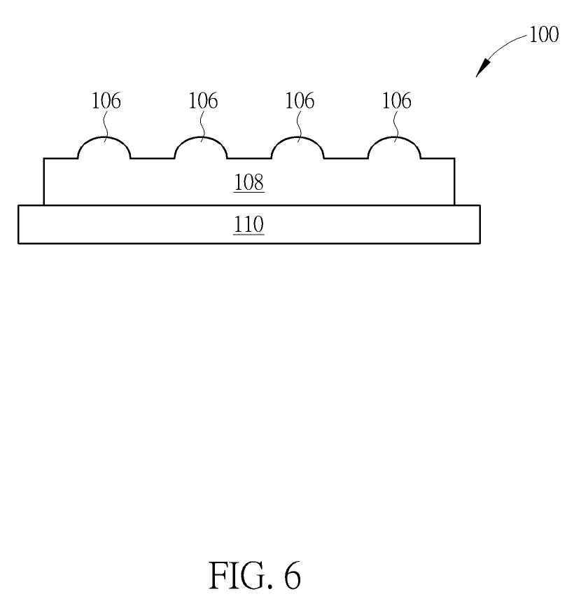

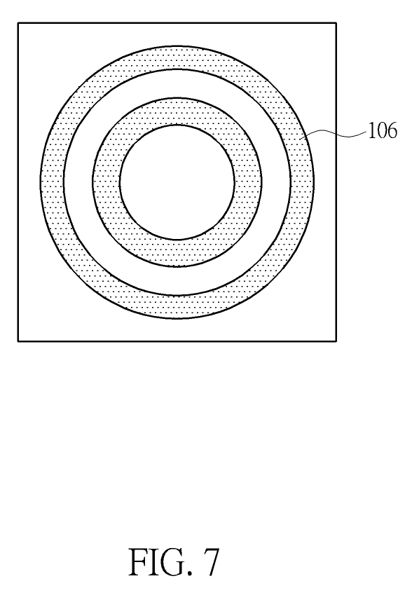

As shown in FIG. 4, an optical glue layer 108 jetted on the lens parts 160 wherein the optical glue layer can comprise a UV glue material same as the optical glue material in the lens mold cavities 104. As shown in FIG. 5, a transparent substrate 110 is formed on the optical glue layer 108, and the optical glue layer 108 is exposed to be hardened so as to combine the transparent substrate 110, the optical glue layer 108, and the lens parts 106, wherein the transparent substrate 110 can be a glass substrate. As shown in FIG. 6, the mold 102 is removed to form the high sag lens array 100, wherein the high sag lens array 100 has a height of over 300 micrometers. In this way, the present invention can use a semiconductor process to fabricate the high sag lens array 100 having a good formation without the bubble issue. Please refer to FIG. 7. FIG. 7 is a diagram showing a top view of one lens part 106 in the high sag lens array 100. Please note that the embodiment is merely for an illustrative purpose and is not meant to be a limitation of the present invention. For example, the number of the lens mold cavities 104 and the lens parts 106 can be changed according to different design requirements.

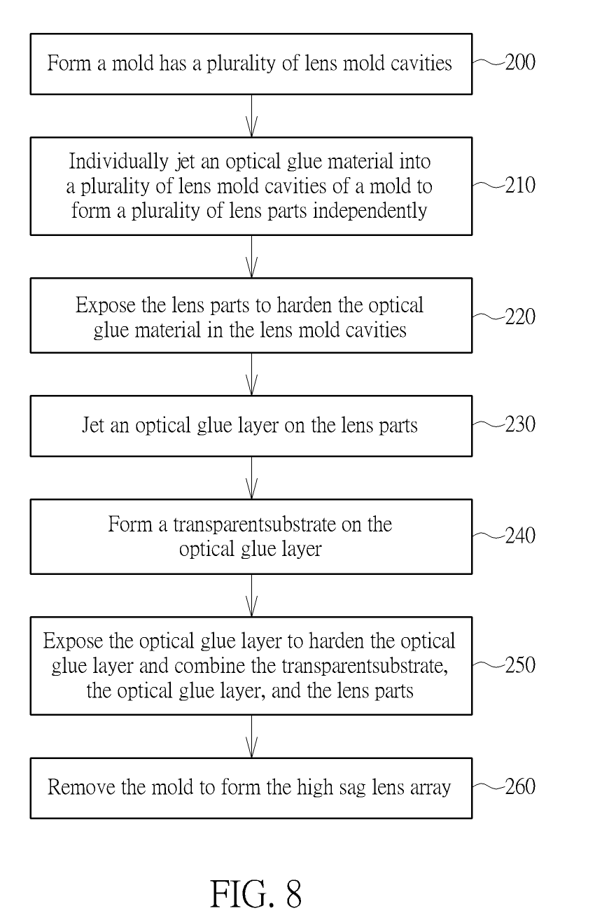

Please refer to FIG. 8. FIG. 8 is a flowchart of a method for fabricating a high sag lens array according to an embodiment of the present invention. Provided that substantially the same result is achieved, the steps of the process flowchart do not have to be in the exact order shown in FIG. 8 and need not be contiguous, meaning that other steps can be intermediate. The method comprises the following steps:

Step 200: Form a mold has a plurality of lens mold cavities.

Step 210: Individually jet an optical glue material into a plurality of lens mold cavities of a mold to form a plurality of lens parts independently.

Step 220: Expose the lens parts to harden the optical glue material in the lens mold cavities.

Step 230: Jet an optical glue layer on the lens parts.

Step 240: Form a transparent substrate on the optical glue layer.

Step 250: Expose the optical glue layer to harden the optical glue layer and combine the transparent substrate, the optical glue layer, and the lens parts

Step 260: Remove the mold to form the high sag lens array.

Briefly summarized, the present invention can use a semiconductor process to fabricate a high sag lens array with a height of over 300 micrometers, each lens in the high sag lens array has a good formation without the bubble issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for fabricating a high sag lens array, comprising:
individually jetting an optical glue material into a plurality of lens mold cavities of a mold to form a plurality of lens parts independently;
exposing the lens parts to harden the optical glue material in the lens mold cavities;
jetting an optical glue layer on the lens parts;
forming a transparent substrate on the optical glue layer;
exposing the optical glue layer to harden the optical glue layer and combine the transparent substrate, the optical glue layer, and the lens parts; and
removing the mold to form the high sag lens array.

2. The method of claim 1, wherein the lens mold cavities have a depth of over 300 micrometers.

3. The method of claim 1, wherein the optical glue material is an ultraviolet (UV) glue material.

4. The method of claim 1, wherein the optical glue layer comprises a UV glue material.

5. The method of claim 1, wherein the transparent substrate is a glass substrate.

6. A high sag lens array, comprising:
a transparent substrate;
an optical glue layer, formed on the glass substrate; and
a plurality of lenses, formed on the optical glue layer, having a height of over 300 micrometers.

7. The high sag lens array of claim 6, wherein the optical glue layer comprises a UV glue material.

8. The high sag lens array of claim 6, wherein the lenses comprise a UV glue material.

9. The high sag lens array of claim 6, wherein the transparent substrate is a glass substrate.

10. The high sag lens array of claim 6, being fabricated by a semiconductor process.
